(19) United States
(12) Patent Application Publication
(10) Pub. No.: US 2020/0389903 A1
(43) Pub. Date: Dec. 10, 2020

(54) Method and Apparatus for Transmitting Data From a Wireless Device to a Network

(71) Applicant: Telefonaktiebolaget LM Ericsson (publ), Stockholm (SE)

(72) Inventors: Ritesh Shreevastav, Upplands Väsby (SE); Andreas Höglund, Solna (SE); Yuhang Liu, Lund (SE); Yutao Sui, Solna (SE); Emre Yavuz, Stockholm (SE)

(21) Appl. No.: 16/971,479

(22) PCT Filed: Mar. 8, 2019
(86) PCT No.: PCT/EP2019/055877

§ 371 Date: Aug. 20, 2020

Related U.S. Application Data
(60) Provisional application No. 62/640,229, filed on Mar. 8, 2018.

(51) Int. Cl. H04W 72/08; H04W 72/04; G16Y 20/30; G16Y 10/75

(52) U.S. Cl. CPC H04W 72/082; G16Y 10/75; G16Y 20/30; H04W 72/0413

(57) ABSTRACT

Apparatus and methods are provided for transmission of data from a wireless device to a network. In one aspect, a method in a user equipment (UE) of transmitting data to a network comprises sending a request to the network for transmission of the data to the network, and transmitting the data to the network using a first carrier, wherein the first carrier is from a first set of one or more carriers or a second set of carriers different to the first set, and wherein the carrier is from the first set or the second set dependent on a parameter of the data.

### TECHNICAL FIELD

Examples of the present disclosure relate to methods, apparatus and computer-readable media for transmitting data from a wireless device to a network.

### BACKGROUND

Narrowband Internet of Things (NB-IoT) is a system for cellular Internet of Things (IoT) devices. The system provides access to cellular network services using a physical layer optimized for very low power consumption (e.g. full carrier bandwidth is 180 kHz, subcarrier spacing can be 3.75 kHz or 15 kHz). The system is based on existing LTE systems and is intended for communications from devices that have low throughput (e.g. 2 kpbs) and low delay sensitivity (e.g. 10 seconds).

Three different operation modes for NB-IoT are defined, which are stand-alone, guard-band, and in-band. In stand-alone mode, the NB-IoT system uses carriers in dedicated frequency bands. For in-band operation, the NB-IoT system can use carriers in a frequency band used by an LTE system, while in the guard-band mode, the NB-IoT system can use carriers in a guard band used by an LTE system. When multi-carriers are configured, several 180 kHz physical resource blocks (PRBs) can be used, for example increasing the system capacity, inter-cell interference coordination, load balancing and/or other reasons.

The channel raster of the downlink of NB-IoT systems is on a frequency grid of 100 kHz. That is, NB-IoT devices search for NB-IoT carriers in a step size of 100 kHz. For in-band and guard-band operation, there may be no PRB that falls directly on the 100 kHz search grid. The frequency offset to the 100 kHz grid for a carrier can be located at a frequency of ±2.5 kHz and ±7.5 kHz from the 100 kHz grid, for even and odd number of PRBs in the LTE system bandwidth respectively. This is illustrated in FIG. 1, which shows examples 100 of PRBs in-band, for an even and an odd number of PRBs, and in a guard band. In the example for an even number of in-band PRBs, for instance, the NB-IoT device may find PRBs n−6 and n+5, as these are located at −2.5 kHz from the 100 kHz grid.

The ±2.5 kHz or ±7.5 kHz offset from the 100 kHz grid can be handled by a NB-IoT device during the cell search process and then be compensated. However, these offsets constrain the positions where NB-IoT carriers can be deployed for the in-band and guard-band operations. Therefore, for a NB-IoT downlink carrier that contains synchronization signal and system information, a carrier must be used with a frequency that is near a 100 kHz grid point (i.e. within ±2.5 kHz or ±7.5 kHz, for an even and odd number of PRBs in the LTE system bandwidth respectively). Information received on this carrier, which is referred to as an anchor carrier, by an NB-IoT device can indicate carriers with other frequencies useable by the device that do not need to be located at or near the 100 kHz grid.

In a Frequency Division Duplex (FDD) system, the uplink and downlink carriers may use different frequencies, whereas in a Time Division Duplex (TDD) system, the uplink and downlink carriers may use the same frequency or different frequencies.

### SUMMARY

One aspect of the disclosure provides a method in a user equipment (UE) of transmitting data to a network. The method comprises sending a request to the network for transmission of the data to the network, and transmitting the data to the network using a first carrier, wherein the first carrier is from a first set of one or more carriers or a second set of carriers different to the first set, and wherein the carrier is from the first set or the second set dependent on a parameter of the data.

Another aspect of the disclosure provides a method in a node in a wireless network of receiving data from a User Equipment (UE). The method comprises receiving a request from the UE for transmission of the data to the network, and receiving the data from the UE using a first carrier, wherein the first carrier is from a first set of one or more carriers or a second set of carriers different to the first set, and wherein the carrier is from the first set or the second set dependent on a parameter of the data.

A further aspect of the disclosure provides a wireless device for transmitting data to a network. The wireless device comprises a processor and a memory. The memory contains instructions executable by said processor such that said wireless device is operative to send a request to the network for transmission of the data to the network, and transmit the data to the network using a first carrier, wherein the first carrier is from a first set of one or more carriers or a second set of carriers different to the first set, and wherein the carrier is from the first set or the second set dependent on a parameter of the data.

A still further aspect of the disclosure provides a network node for receiving data from a wireless device. The network node comprises a processor and a memory. The memory contains instructions executable by said processor such that said network node is operative to receive a request from the wireless device for transmission of the data to the network, and receive the data from the wireless device using a first carrier, wherein the first carrier is from a first set of one or more carriers or a second set of carriers different to the first set, and wherein the carrier is from the first set or the second set dependent on a parameter of the data.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic illustration of examples of PRBs in-band and in a guard band;

FIG. 2 is a flow chart of an example of a method in a User Equipment (UE) for transmitting data to a network;

FIG. 3 is a flow chart of an example of a method in a node in a wireless network of receiving data from a User Equipment (UE);

FIG. 4 is a schematic of an example of a wireless device for transmitting data to a network;

FIG. 5 is a schematic of an example of a network node for receiving data from a wireless device;

FIG. 6 is ASN.1 code of an example of establishment causes that can be used by a device to access a network;

FIG. 7 is ASN.1 code of an example of establishment causes that can be used by a device to access a network;

FIG. 8 is ASN.1 code of an example of a part of a System Information Block (SIB);

FIG. 9 is ASN.1 code of an example of establishment causes that can be used by a device to access a network;

FIG. 10 illustrates an example of a wireless network;

FIG. 11 illustrates an embodiment of a UE; and

FIG. 12 illustrates an embodiment of a communication system.

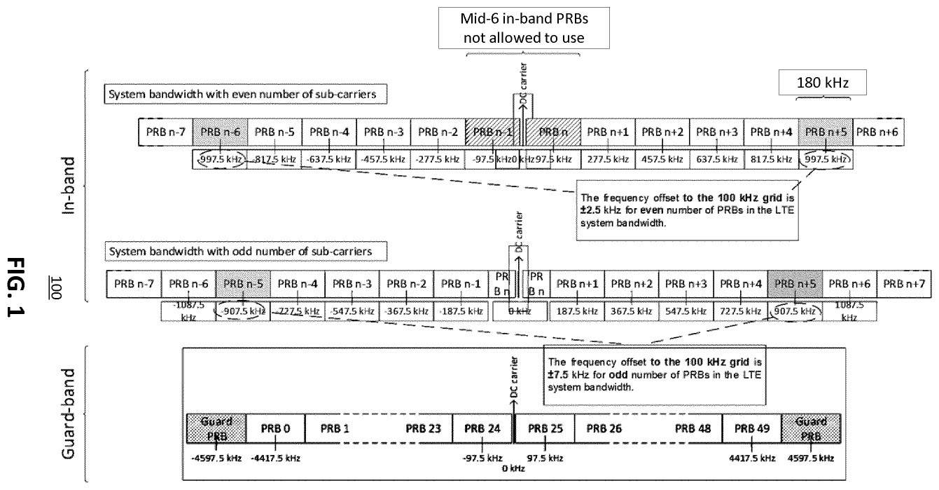

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

A NB-IoT device is generally expected to transmit delay tolerant data, e.g. transmission of the data to the network may be delayed by up to several seconds, and/or delivery to the destination of the data, e.g. an intended recipient or a data processing center, may be delayed by up to several seconds. Delay tolerant data may, however, be data that can be delayed by up to a different length of time in other examples, such as for example up to 0.5 seconds, 1 second, 5 seconds, 20 seconds or any other length of time. However, in some cases, there may be occurrences when the latency and/or reliability of transmission of data is relevant, such as for example for alarm or exception events to be reported by a NB-IoT device.

Embodiments of this disclosure provide a system, method and/or apparatus for ensuring that data, such as for example NB-IoT data (i.e. data from a NB-IoT device) can be transmitted to a network with low latency and/or high reliability for some data (e.g. alarm or exception data) compared to other data. In some embodiments, carriers that can be used for uplink transmission of data from a device to a network can be placed in at least two sets, each set containing one or more carriers. The carrier that is used to upload data from a device can be taken either from one set or the other set depending on one or more parameters of the data. A parameter may be, for example, a latency or reliability constraint for the data, whether the data relates to alarm or exception data, or any other parameter. Effectively, in some embodiments, one or more carriers are reserved for data that has these one or more parameters, lowering usage of these carriers for more “regular” (e.g. delay tolerant) data, and thus tending to decrease latency and/or increase reliability for transmission of the data. In some embodiments, each carrier may be in either on set or the other set, and each carrier may be in-band (e.g. in a LTE or New Radio, NR, band), in a guard band, or standalone.

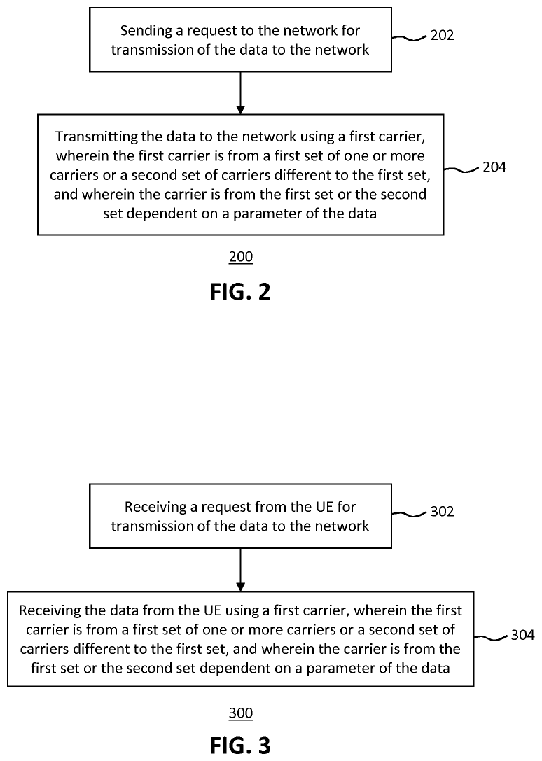

FIG. 2 shows an embodiment of a method 200 in a user equipment (UE), such as for example a NB-IoT device, of transmitting data to a network. The UE may be for example a NB-IoT device that transmits NB-IoT data to the network. The network may be for example an LTE or New Radio (NR) network. The method 200 comprises, in step 202, sending a request to the network for transmission of the data to the network, and in step 204, transmitting the data to the network using a first carrier, wherein the first carrier is from a first set of one or more carriers or a second set of carriers different to the first set, and wherein the carrier is from the first set or the second set dependent on a parameter of the data.

Thus, in some embodiments, the first carrier (which may be specifically requested by the UE or indicated by the network, for example) uses a frequency dependent on the parameter of the data. If, for example, the carriers in one of the sets such as the first set are effectively reserved for data having a particular parameter, transmission of this data using an effectively reserved carrier may be more reliable and/or have lower latency than other data that is transmitted using a carrier in the other set. In some examples, the carriers may be in an LTE or NR band, in a guard band, or standalone carriers.

In some embodiments, the request indicates the parameter of the data, and the method comprises receiving an indication of the first carrier in response to the request. Thus the network, such as for example an eNB or another node, may select the carrier from the first set or the second set based on the parameter of the data that the UE is requesting to transmit.

In some examples, the request may indicate a desired carrier, i.e. an alternative carrier to the first carrier. While the network may accept the UE's choice of first carrier, in some cases it may not be desirable to use the requested first carrier for transmission of the data. For example, the first carrier may be subject to interference or increased traffic load. Therefore, the UE may, in response to the request, receive an instruction (e.g. from the network) to use a carrier chosen by the network instead of the alternative carrier requested by the UE. The alternative carrier may in some embodiments be in the same set as the first carrier. As a result of using the alternative carrier, the problems of interference or traffic load on the first carrier may be avoided.

In some examples, the request may indicate the first carrier, and hence the first carrier may be chosen by the UE. However, the first set and/or second set may contain only one carrier, and the carrier chosen from the first set or the second set based on the parameter of the data may be the only carrier available to the UE to transmit the data having that parameter.

The request may in some embodiments be sent using the first carrier or an anchor carrier. If sent using the first carrier, the use of the first carrier may in some examples be an implied request to use that carrier to transmit the data, though the request may still explicitly indicate the first carrier in other examples.

In some examples, the method 200 also includes determining a list of carriers ordered based on a characteristic of the carriers, wherein the first set of one or more carriers comprises one or more first carriers in the list, and the second set of one or more carriers comprises carriers in the list not in the first set. Therefore, depending on the parameter of the data to be transmitted, either a carrier from the first one or more carriers in the list is requested, or one of the other one or more carriers (e.g. towards the bottom of the list) is used. For example, the first carrier in the list in the appropriate set may be requested. In some embodiments, this may effectively reserve the first one or more carriers in the list for data having a particular parameter. The characteristic of the carriers may comprise, for example, uplink Received Signal Strength Indicator (RSSI), uplink Signal to Interference and Noise Ratio (SINR), uplink interference level, downlink RSSI, downlink SINR and/or downlink interference level. In an example, the carriers may be ordered based on RSSI, such that the strongest carriers are at the top of the list. The first one or more carriers, which are the strongest carrier(s), may then be reserved for data having a particular parameter, such as a requirement for high reliability or low latency, being alarm or exception data, being delay sensitive, and/or any other parameter. Transmission of the data having this parameter may therefore have low latency and/or high reliability compared to data transmitted using a carrier lower in the list in a different set.

In some embodiments, the list of carriers may be received from the network. In other embodiments, the list may be generated by the UE, e.g. using measurements of downlink signals. A measurement for a downlink carrier may in some cases provide a suggestion of the state of a corresponding uplink carrier. In some embodiments, the UE may send a downlink quality report to the network, which can be used to prepare the list of carriers. The network may in some examples perform statistical aggregation of the report from several UEs to prepare the list of carriers.

In some embodiments, the method comprises receiving an indication of the first set from the network, and receiving an indication of the second set from the network. For example, the indication may be a list of carrier(s) in the first set, and a list of carrier(s) in the second set. Where a list of carriers is received from the network by the UE, or an indication of the first and second sets, this may be in some examples an instruction effectively to use a particular carrier or carriers for certain types of data, e.g. delay-sensitive or non-delay tolerant data.

In some embodiments, the list of carriers or indication of the first and second sets may be received over an anchor carrier, e.g. in one or more System Information Blocks (e.g. SIB1 or another SIB) and/or Master Information Blocks (MIBs). Thus, for example, the UE may receive this information over a carrier found in an initial search for a communications system (e.g. NB-IoT system). However, in some cases the UE may not receive the information. Therefore, in some embodiments, the UE may use the anchor carrier or another, predetermined carrier as a “default” carrier for uplink transmissions for data with a certain parameter (e.g. low latency or high reliability requirement). Thus the anchor carrier or other, predetermined may be reserved for such data. In other embodiments, the anchor carrier may always be included in the first set. In some embodiments, the network may transmit downlink data, System Information Blocks (SIBs), MIBs, synchronization data and/or other transmissions using an anchor carrier that is transmitted at a higher power than other carriers to ensure reliable reception by devices. If a list is ordered for example by a downlink parameter such as RSSI measured by the UE, the anchor carrier is likely to be at or near the top of the list and hence is likely to be included in the first set by UEs within the transmission area of the network or the anchor carrier.

The request to the network may in some embodiments be a Radio Resource Control (RRC) Connection Request, which may be sent before the UE begins transmission of the data to the network. The RRC Connection Request may in some cases be sent using the first carrier (i.e. the carrier that the UE wishes to use for transmission of the data) or another, predetermined carrier such as an anchor carrier. In some cases, the RRC Connection Request indicates the first carrier. For example, the RRC Connection Request may contain information that identifies the carrier that the UE wishes to use. Additionally or alternatively, the RRC Connection Request identifies the parameter of the data, e.g. the latency requirement or the reliability requirement, or whether the data is alarm or exception data.

In some embodiments, the method 200 includes selecting the first carrier by selecting a carrier from the first set or a carrier from the second set based on the parameter of the data. Thus the UE selects the carrier it wishes to use. Alternatively, for example, the carrier to use may be indicated by the network. For example, the network may indicate that data with a particular parameter (e.g. delay sensitive data) should use one or more specified carriers, and other data should not use these carriers.

In some embodiments, the parameter of the data may be any parameter or property of the data or the transmission of the data. Examples of parameters include, but are not limited to, the latency or latency requirement, reliability or reliability requirement, data rate, or bandwidth requirement of the data or the transmission of the data. Table 1 below provides examples of relative desirable properties for mMTC, Rel-16 NR-IoT SI, and URLLC communication systems in various areas:

TABLE 1

| Requirements & | | | |
|---|---|---|---|
| Characteristics | mMTC | Rel-16 NR-loT Sl | URLLC |
| Latency | High | Low-Medium | Low to ultra-low |
| Reliability | Medium | High | Ultra-high |
| Data rate | Low | Low-Medium | Medium-High |
| Device complexity | Low | Medium | High |
| Coverage | Extreme | Normal | Normal |
| Battery life | Very long | Medium or not | Not applicable |
| | | applicable | (e.g. mains |
| | | (e.g. mains | powered) |
| | | powered) | |
| Positioning | Low | High | High |
| accuracy | | | |
| Connection density | Very high | Low-High | Low-High |
| BW requirement | Narrow | Normal-Wide | Normal-Wide |

At least some of the areas, for example bandwidth (BW) requirement and latency, may be a parameter property of the data or transmission of the data. Data for transmission using a carrier in the first set may have a different parameter to data for transmission using a carrier in the second set. For example, data for transmission using a carrier in the first set (“data for the first set”) may have a lower latency requirement or constraint than data for transmission using a carrier in the second set (“data for the second set”). Referring to the table above for example, data for the second set may have a low to medium latency requirement (or tolerance, in that a low to medium latency in transmission of that data may be tolerated), whereas data for the first set may have a lower latency requirement, such as for example a low to ultra-low latency requirement. Similarly, additionally or alternatively, data for the second set may have a high reliability requirement, whereas data for the first set may have a higher reliability requirement such as for example an ultra-high latency requirement. In a different example, data for the second set may have a high latency requirement (or tolerance) and/or a medium reliability requirement, whereas data for the first set may have a low to medium latency requirement and/or a high reliability requirement, or data for the first set may have a low to ultra-low latency requirement and/or an ultra-high reliability requirement. These represent examples of parameters of the data and other parameters and/or values of parameters used to categorize data to use a carrier in the first set or a carrier in the second set may be used in other embodiments.

FIG. 3 is a flow chart of an example of a method 300 in a node in a wireless network of receiving data from a User Equipment (UE), such as in a node in a LTE or NR network. The UE may be a device such as for example a NB-IoT device, or NR-mMTC device. The method 300 comprises, in step 302, receiving a request from the UE for transmission of the data to the network, and in step 304, receiving the data from the UE using a first carrier, wherein the first carrier is from a first set of one or more carriers or a second set of carriers different to the first set, and wherein the carrier is from the first set or the second set dependent on a parameter of the data. Thus, for example, certain carriers (e.g. the first set) may be effectively reserved for data transmissions from one or more UEs where the data has a certain parameter, such as for example a delay tolerance constraint, reliability constraint, whether the data is delay-sensitive, whether the data is alarm or exception data, and/or any other parameter.

In some embodiments, the request indicates the parameter of the data. The method 300 may therefore comprise sending an indication of the first carrier to the UE in response to the request. For example, the node may choose a set based on the parameter of the data, choose a carrier from the set and send an indication of the carrier to the UE. The UE may then transmit the data to the network using the carrier. In some cases, the request may indicate an alternative carrier, which may be undesirable for use due to for example traffic loading levels on that carrier. In this case, the node may send an instruction to the UE to use the first carrier instead of the requested alternative carrier. The first carrier and the alternative carrier may be in the same set.

An indication of the first and second sets may be sent to the UE in some embodiments. For example, the method 300 may comprise determining a list of carriers ordered based on a characteristic of the carriers, wherein the first set of one or more carriers comprises one or more first carriers in the list, and the second set of one or more carriers comprises carriers in the list not in the first set. The characteristic may be for example uplink Received Signal Strength Indicator (RSSI), uplink Signal to Interference and Noise Ratio (SINR), uplink interference level, downlink RSSI, downlink SINR and/or downlink interference level. In some examples, where the first carrier(s) in the list are ordered such that the strongest carriers (e.g. by RSSI) are listed first, and hence are in the first set, these carriers may be effectively reserved for data with a particular parameter, such as for example delay sensitive data or data with a high reliability requirement, or alarm or exception data.

In some examples, the list of carriers or the indication of the first and second sets of carriers to the UE over an anchor carrier. Thus a UE or NB-IoT device may receive the list over a carrier that is for example at or near a 100 kHz grid. The list or indication may be sent in one or more System Information Blocks (SIBs) or Master Information Blocks (MIBs).

In some embodiments, the request from the UE comprises receiving a Radio Resource Control (RRC) Connection Request, received over the first carrier or another, predetermined carrier such as an anchor carrier. The RRC Connection Request may in some examples indicate the selected carrier and/or the parameter of the data.

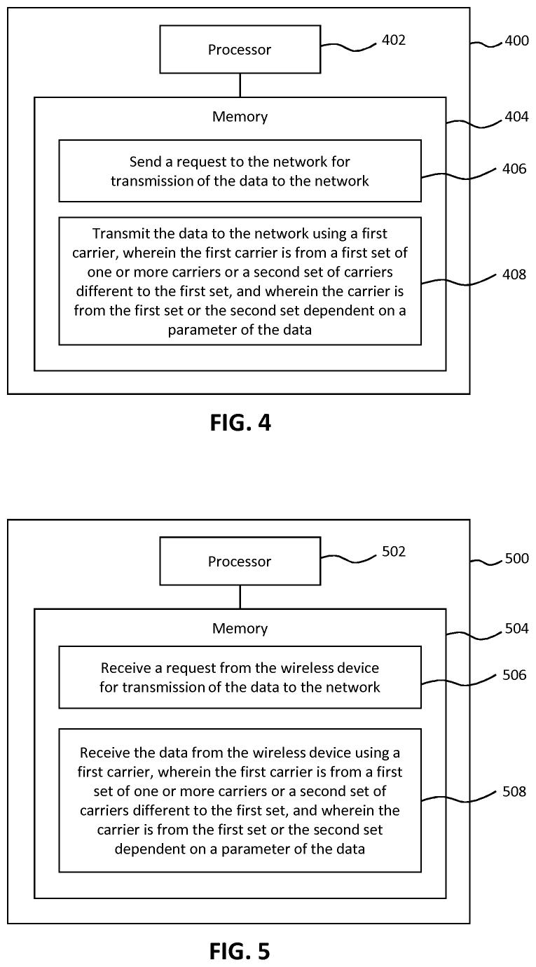

FIG. 4 shows a schematic of an example of a wireless device 400 for transmitting data to a network. The wireless device comprises a processor 402 and a memory 404. The memory 404 contains instructions 406 executable by said processor 402 such that said wireless device 400 is operative to send a request to the network for transmission of the data to the network. The memory 404 also contains instructions 408 executable by said processor 402 such that said wireless device 400 is operative to transmit the data to the network using a first carrier, wherein the first carrier is from a first set of one or more carriers or a second set of carriers different to the first set, and wherein the carrier is from the first set or the second set dependent on a parameter of the data.

FIG. 5 shows a schematic of an example of a network node 500 for receiving data from a wireless device such as a UE or NB-IoT device. The network node 500 comprises a processor 502 and a memory 504. The memory 504 contains instructions executable by said processor 502 such that said network node 500 is operative to receive a request from the wireless device for transmission of the data to the network. The memory 504 also contains instructions executable by said processor 502 such that said network node 500 is operative to Receive the data from the wireless device using a first carrier, wherein the first carrier is from a first set of one or more carriers or a second set of carriers different to the first set, and wherein the carrier is from the first set or the second set dependent on a parameter of the data.

In some embodiments, a device may include processing circuitry configured to perform a method as disclosed herein, and power supply circuitry configured to supply power to the device. The device may be for example a network node or base station for receiving data from a wireless device or a UE, or a wireless device for transmitting data to a network.

Particular example embodiments will be now be described.

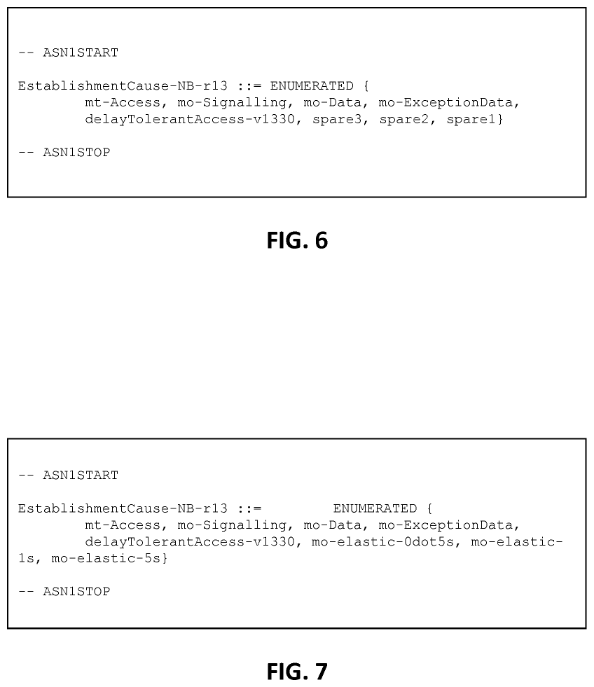

Currently when NB-IoT device access the network, the establishment causes that can be used are shown in FIG. 6. Currently, in NB-IoT, mo-ExceptionData is used to indicate an exceptional report (i.e. data), e.g., alarm type of report by the UE. In some embodiments, upon receiving the establishment cause, if the UE indicates mo-ExceptionData, the network can choose a downlink carrier that is preferred by the UE (e.g. a reserved carrier) to schedule the UE for subsequent communication of the report.

In some embodiments, the UE can report its preferred downlink carrier to the network together with the establishment cause information. The UE may choose this carrier based on the establishment cause information.

In some embodiments, the establishment cause (where a reserved carrier is used to transmit data) is extended for delay sensitive data other than mo-ExceptionData, for example data communication that is not emergency, but is required to be handled within a given amount of time, e.g., asset tracking or monitoring sensor device in a patient's body etc. For these cases, establishment cause with delaySensitiveAccess can be added to the above list which a UE can only use for such data transmission. The UE may also indicate its preferred time during which the report needs to be handled. A non-exclusive example is given as follows. In this example, the UE can indicate that it would like to have its UL report to get through to a destination within 0.5 seconds, 1 seconds or 5 seconds. FIG. 7 illustrates an example of establishment causes which can be used to indicate such preferred time.

In some embodiments, the network (NW) can inform the NB-IoT device through broadcast a mechanism (e.g. SIB) which NB-IoT carrier(s) the UE can use (or request to use) for delay sensitive data, e.g. mo-ExceptionData or other type of non-delay tolerant access. Similarly, the NW can provide a prioritized list of NB-IoT carriers which the UE can try to access accordingly for different types of UL report. The carriers will be sorted in some order with respect to power boost or frequency fading information, UL RSSI etc. For sensitive data, UE can use the top most carrier, and for delay-tolerant data one of the lower ones. However, if NW does not broadcast any such information or the information is not received by the UE, the UE should use the anchor carrier for delay sensitive data transfer and a non-anchor carrier for other types. Alternately, the NW can broadcast information identifying two sets of UL carriers for random access, one set for delay sensitive services and data and the other set for delay-tolerant services and data. The UE may in some examples randomly select one of the carriers from either one of the two UL carrier sets for random access, depending on what type of service it is requesting or what type of data it wishes to transmit.

In some embodiments, as a NB-IoT system carries data mostly in the UL direction, the order of the list of carriers is based upon an UL characteristic of the link, such as interference level, UL RSSI and the like.

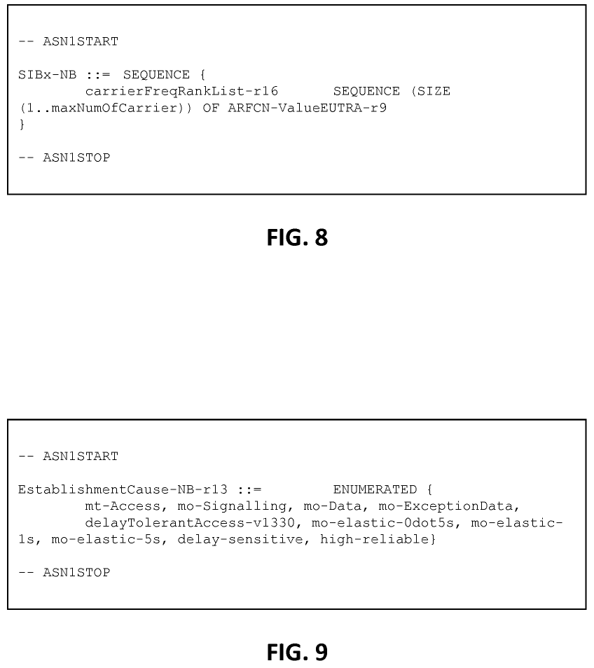

In some embodiments, an ASN.1 example is provided for the SIB Broadcast of the Ranked/Sorted Carriers as shown in FIG. 8.

NW can also sort the DL carrier which is associated to UL based upon power boost and the traffic situation (heavily or lightly loaded).

The NW can thus based upon above criteria reserve the best carriers for delay-sensitive services.

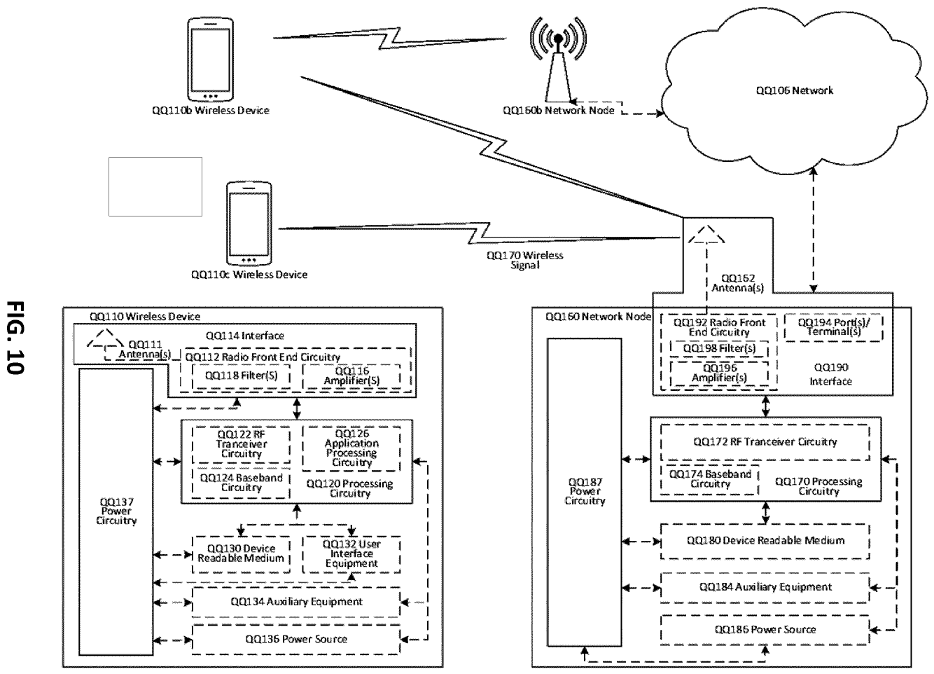

In some embodiments, a redirection can be performed by eNB. The redirection can be implemented based upon the establishment cause such as “delay-sensitive service type or data”. Based on the establishment caused indicated by the UE, the NW can assign appropriate UL and DL carriers for the UE, for example in the RRC connection setup/resume procedure. FIG. 9 shows an example of establishment causes that include delay-sensitive and high-reliable requirements.

In some embodiments, the NW, upon receiving a request to access a carrier to transmit data with a certain parameter, e.g. a delay sensitive access request, can provide a redirection message which includes second carrier access information (e.g. PRB location), for example when the first carrier cannot serve that UE due to high load or any other reason. In some examples, the indication is for long term use and should be used by the UE also for subsequent access attempts for data with the same parameter or a parameter that results in a request to use the same carrier or a carrier from the same set, for example. The carrier here may also be referred to in some examples as narrowbands in eMTC (LTE-M) or PRBs or anchor or non-anchor carriers in NB-IoT.

In some embodiments, there may be a charging policy that can be applied for mo-ExceptionData or other type of non-delay tolerant access. If the UE chooses to use the resource that is reserved for mo-ExceptionData or other type of non-delay tolerant access, the operator can impose charges. This may ensure that UEs do not abuse services such as carriers reserved for delay-sensitive data.

Advantages provided by embodiments of the disclosure include ensuring that data with particular requirements such as latency or reliability may be transmitted to the network in a manner that may meet those requirements, even using a system for transmitting data that is expected to be delay tolerant.

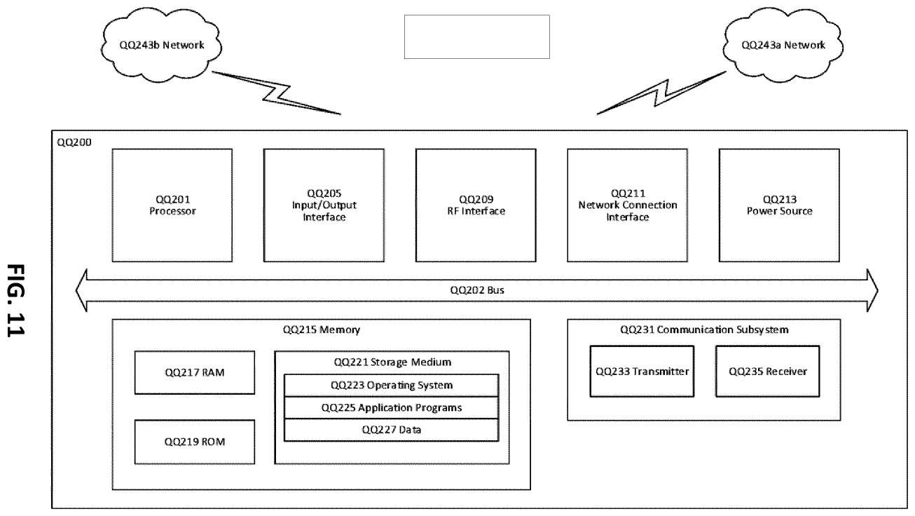

Although the subject matter described herein may be implemented in any appropriate type of system using any suitable components, the embodiments disclosed herein are described in relation to a wireless network, such as the example wireless network illustrated in FIG. 10.

For simplicity, the wireless network of FIG. 10 only depicts network QQ106, network nodes QQ160 and QQ160b, and WDs QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), LTE-M (eMTC), NR-mMTC and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160. Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signaling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components. In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used. Alternative embodiments of network node QQ160 may include additional components beyond those shown in FIG. 10 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally. Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems. Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 11, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

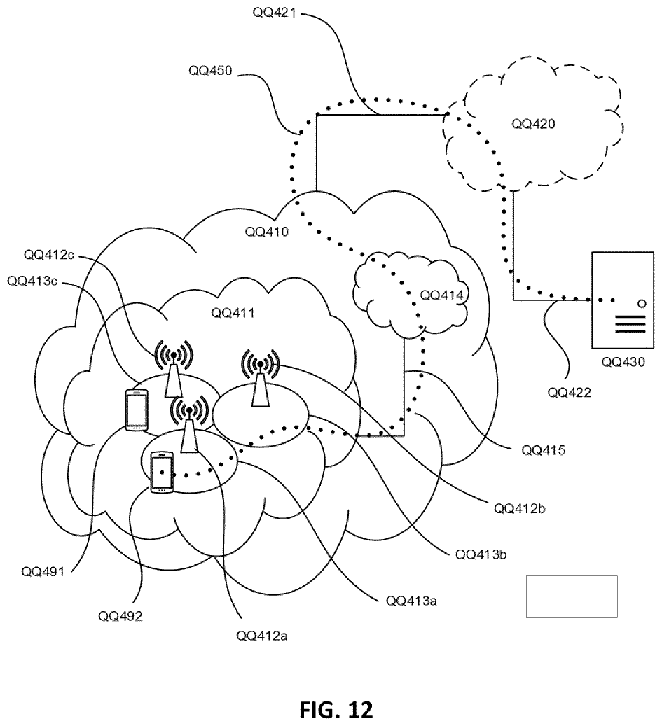

With reference to FIG. 12, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 12 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim or embodiment, “a” or “an” does not exclude a plurality, and a single processor or other unit may fulfill the functions of several units recited in the statements below. Where the terms, “first”, “second” etc are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

Particular embodiments are disclosed below.

### Embodiment 1

A method in a user equipment (UE) of transmitting data to a network, the method comprising:
sending a request to the network for transmission of the data to the network; and
transmitting the data to the network using a first carrier, wherein the first carrier is from a first set of one or more carriers or a second set of carriers different to the first set, and wherein the carrier is from the first set or the second set dependent on a parameter of the data.

### Embodiment 2

The method of embodiment 1, wherein the request indicates the parameter of the data, and the method comprises receiving an indication of the first carrier in response to the request.

### Embodiment 3

The method of embodiment 1 or 2, wherein the request indicates an alternative carrier, and the method comprises receiving, in response to the request, an instruction to use the first carrier.

### Embodiment 4

The method of embodiment 3, wherein the alternative carrier is in the same set as the first carrier.

### Embodiment 5

The method of embodiment 1, wherein the request indicates the first carrier.

### Embodiment 6

The method of any of the preceding embodiments, wherein sending a request to the network comprises sending the request using the first carrier or an anchor carrier.

### Embodiment 7

The method of any of the preceding embodiments, comprising determining a list of carriers ordered based on a characteristic of the carriers, wherein the first set of one or more carriers comprises one or more first carriers in the list, and the second set of one or more carriers comprises carriers in the list not in the first set.

### Embodiment 8

The method of embodiment 7, wherein the characteristic comprises uplink Received Signal Strength Indicator (RSSI), uplink Signal to Interference and Noise Ratio (SINR), uplink interference level, downlink RSSI, downlink SINR and/or downlink interference level.

### Embodiment 9

The method of any of embodiment 7 or 8, wherein determining the list of carriers comprises receiving the list of carriers from the network.

### Embodiment 10

The method of any of the preceding embodiments, comprising receiving an indication of the first set from the network, and receiving an indication of the second set from the network.

### Embodiment 11

The method of embodiment 10, wherein receiving the indication of the first and second sets comprises receiving the indication over an anchor carrier.

### Embodiment 12

The method of embodiment 10 or 11, wherein receiving the indication of the first and second sets comprises receiving the indication in one or more System Information Blocks (SIBs) and/or Master Information Blocks (MIBs).

### Embodiment 13

The method of any of the preceding embodiments, wherein sending the request to the network comprises, if an indication of the first and second sets is not received from the network, sending a request to the network to use an anchor carrier or a carrier other than the anchor carrier based on the parameter of the data.

### Embodiment 14

The method of any of the preceding embodiments, wherein the first set of one or more carriers comprises an anchor carrier.

### Embodiment 15

The method of any of the preceding embodiments, wherein sending the request to the network comprises sending a Radio Resource Control (RRC) Connection Request.

### Embodiment 16

The method of any of the preceding embodiments, comprising selecting the first carrier by selecting a carrier from the first set or a carrier from the second set based on the parameter of the data.

### Embodiment 17

The method of any of the preceding embodiments, wherein the parameter comprises one or more of a delay tolerance, a data type, a latency constraint, a reliability requirement and an exception indicator.

### Embodiment 18

The method of any of the preceding embodiments, wherein each carrier is in either the first set or the second set.

### Embodiment 19

The method of any of the preceding embodiments, wherein the data comprises Narrowband Internet-of-Things (NB-IoT) data.

### Embodiment 20

The method of any of the preceding embodiments, wherein the UE comprises a Narrowband Internet-of-Things (NB-IoT) device.

### Embodiment 21

The method of any of the preceding embodiments, wherein the network comprises a Long Term Evolution (LTE) network or New Radio (NR) network.

### Embodiment 22

The method of any of the preceding embodiments, wherein the carriers in the first and second sets are in a Long Term Evolution (LTE) band or New Radio (NR) band.

### Embodiment 23

The method of any of the preceding embodiments, wherein the carriers in the first set are reserved for transmission of data having a predetermined value of the parameter.

### Embodiment 24

A method in a node in a wireless network of receiving data from a User Equipment (UE), the method comprising:
receiving a request from the UE for transmission of the data to the network; and receiving the data from the UE using a first carrier, wherein the first carrier is from a first set of one or more carriers or a second set of carriers different to the first set, and wherein the carrier is from the first set or the second set dependent on a parameter of the data.

### Embodiment 25

The method of embodiment 24, wherein the request indicates the parameter of the data, and the method comprises sending an indication of the first carrier to the UE in response to the request.

### Embodiment 26

The method of embodiment 24 or 25, wherein the request indicates an alternative carrier, and the method comprises sending, in response to the request, an instruction to use the first carrier to the UE.

### Embodiment 27

The method of embodiment 26, wherein the alternative carrier is in the same set as the first carrier.

### Embodiment 28

The method of embodiment 26 or 27, comprising sending the instruction to the UE based on a traffic level of the selected carrier.

### Embodiment 29

The method of embodiment 24, wherein the request indicates the first carrier.

### Embodiment 30

The method of any of embodiments 24 to 29, wherein receiving the request from the UE comprises receiving the request using the first carrier or an anchor carrier.

### Embodiment 31

The method of any of embodiments 24 to 30, comprising sending an indication of the first and second sets of carriers to the UE.

### Embodiment 32

The method of embodiment 31, comprising determining a list of carriers ordered based on a characteristic of the carriers, wherein the first set of one or more carriers comprises one or more first carriers in the list, and the second set of one or more carriers comprises carriers in the list not in the first set.

### Embodiment 33

The method of embodiment 32, wherein the characteristic comprises uplink Received Signal Strength Indicator (RSSI), uplink Signal to Interference and Noise Ratio (SINR), uplink interference level, downlink RSSI, downlink SINR and/or downlink interference level.

### Embodiment 34

The method of any of embodiments 31 to 33, comprising sending the indication of the first and second sets of carriers to the UE over an anchor carrier.

### Embodiment 35

The method of any of embodiments 31 to 34, comprising sending the indication of the first and second sets of carriers to the UE in one or more System Information Blocks (SIBs) and/or Master Information Blocks (MIBs).

### Embodiment 36

The method of any of embodiments 24 to 35, comprising receiving the data from the UE using the first carrier.

### Embodiment 37

The method of any of embodiments 24 to 36, wherein receiving the request from the UE comprises receiving a Radio Resource Control (RRC) Connection Request.

### Embodiment 38

The method of any of embodiments 24 to 37, wherein the parameter comprises one or more of a delay tolerance, a data type, a latency constraint, a reliability requirement and an exception indicator.

### Embodiment 39

The method of any of embodiments 24 to 38, wherein each carrier is in either the first set or the second set.

### Embodiment 40

The method of any of embodiments 24 to 39, wherein the data comprises Narrowband Internet-of-Things (NB-IoT) data.

### Embodiment 41

The method of any of embodiments 24 to 40, wherein the network comprises a Long Term Evolution (LTE) network or New Radio (NR) network.

### Embodiment 42

The method of any of embodiments 24 to 41, wherein the carriers in the first and second sets are in a Long Term Evolution (LTE) band or a New Radio (NR) band.

### Embodiment 43

The method of any of embodiments 24 to 42, further comprising:
obtaining user data; and
forwarding the user data to the UE, a host computer or a wireless device.

### Embodiment 44

The method of any of embodiments 24 to 43, wherein the carriers in the first set are reserved for transmission of data having a predetermined value of the parameter.

### Embodiment 45

A wireless device for transmitting data to a network, the wireless device comprising a processor and a memory, said memory containing instructions executable by said processor such that said wireless device is operative to:
send a request to the network for transmission of the data to the network; and
transmit the data to the network using a first carrier, wherein the first carrier is from a first set of one or more carriers or a second set of carriers different to the first set, and wherein the carrier is from the first set or the second set dependent on a parameter of the data.

### Embodiment 46

The wireless device of embodiment 45, wherein said memory contains instructions executable by said processor such that said wireless device is operative to carry out the method of any of embodiments 2 to 23.

### Embodiment 47

A network node for receiving data from a wireless device, the network node comprising a processor and a memory, said memory containing instructions executable by said processor such that said network node is operative to:
receive a request from the wireless device for transmission of the data to the network; and
receive the data from the UE using a first carrier, wherein the first carrier is from a first set of one or more carriers or a second set of carriers different to the first set, and wherein the carrier is from the first set or the second set dependent on a parameter of the data.

### Embodiment 48

The network node of embodiment 47, wherein said memory contains instructions executable by said processor such that said network node is operative to carry out the method of any of embodiments 25 to 44.

### Embodiment 49

A user equipment (UE) for transmitting data to a network, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of embodiments 1 to 23;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

### Embodiment 50

A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of embodiments 24 to 44.

### Embodiment 51

The communication system of embodiment 50 further including the base station.

### Embodiment 52

The communication system of embodiment 50 or 51, further including the UE, wherein the UE is configured to communicate with the base station.

### Embodiment 53

The communication system of any of embodiments 50 to 52, wherein:
the processing circuitry of the host computer is configured to execute a host application, thereby providing the user data; and
the UE comprises processing circuitry configured to execute a client application associated with the host application.

### Embodiment 54

A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of embodiments 24 to 44.

### Embodiment 55

The method of embodiment 54, further comprising, at the base station, transmitting the user data.

### Embodiment 56

The method of embodiment 54 or 55, wherein the user data is provided at the host computer by executing a host application, the method further comprising, at the UE, executing a client application associated with the host application.

### Embodiment 57

A user equipment (UE) configured to communicate with a base station, the UE comprising a radio interface and processing circuitry configured to performs the method of any of embodiments 54 to 56.

### Embodiment 58

A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of embodiments 1 to 23.

### Embodiment 59

The communication system of embodiment 58, wherein the cellular network further includes a base station configured to communicate with the UE.

### Embodiment 60

The communication system of embodiment 58 or 59, wherein:
the processing circuitry of the host computer is configured to execute a host application, thereby providing the user data; and
the UE's processing circuitry is configured to execute a client application associated with the host application.

### Embodiment 61

A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of embodiments 1 to 23.

### Embodiment 62

The method of embodiment 61, further comprising at the UE, receiving the user data from the base station.

### Embodiment 63

A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of embodiments 1 to 23.

### Embodiment 64

The communication system of embodiment 63, further including the UE.

### Embodiment 65

The communication system of embodiment 63 or 64, further including the base station, wherein the base station comprises a radio interface configured to communicate with the UE and a communication interface configured to forward to the host computer the user data carried by a transmission from the UE to the base station.

### Embodiment 66

The communication system of any of embodiments 63 to 65, wherein:
the processing circuitry of the host computer is configured to execute a host application; and
the UE's processing circuitry is configured to execute a client application associated with the host application, thereby providing the user data. cl Embodiment 67

The communication system of any of embodiments 63 to 66, wherein:
the processing circuitry of the host computer is configured to execute a host application, thereby providing request data; and
the UE's processing circuitry is configured to execute a client application associated with the host application, thereby providing the user data in response to the request data.

### Embodiment 68

A method implemented in a communication system including a host computer, a base station and a user equipment (UE), the method comprising:
at the host computer, receiving user data transmitted to the base station from the UE, wherein the UE performs any of the steps of any of embodiments 1 to 23.

### Embodiment 69

The method of embodiment 68, further comprising, at the UE, providing the user data to the base station.

### Embodiment 70

The method of embodiment 68 or 69, further comprising:
at the UE, executing a client application, thereby providing the user data to be transmitted; and
at the host computer, executing a host application associated with the client application.

### Embodiment 71

The method of any of embodiments 68 to 70, further comprising:
at the UE, executing a client application; and
at the UE, receiving input data to the client application, the input data being provided at the host computer by executing a host application associated with the client application,
wherein the user data to be transmitted is provided by the client application in response to the input data.

### Embodiment 72

A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of embodiments 24 to 44.

### Embodiment 73

The communication system of embodiment 72 further including the base station.

### Embodiment 74

The communication system of embodiment 72 or 73, further including the UE, wherein the UE is configured to communicate with the base station.

### Embodiment 75

The communication system of any of embodiments 72 to 74, wherein:
the processing circuitry of the host computer is configured to execute a host application;
the UE is configured to execute a client application associated with the host application, thereby providing the user data to be received by the host computer.

### Embodiment 76

A method implemented in a communication system including a host computer, a base station and a user equipment (UE), the method comprising:
at the host computer, receiving, from the base station, user data originating from a transmission which the base station has received from the UE, wherein the UE performs any of the steps of any of embodiments 1 to 23.

### Embodiment 77

The method of embodiment 76, further comprising at the base station, receiving the user data from the UE.

### Embodiment 78

The method of embodiment 76 or 77, further comprising at the base station, initiating a transmission of the received user data to the host computer.

1-48. (canceled)

49. A method, in a user equipment (UE), of transmitting data to a network, the method comprising:
sending a request to the network for transmission of the data to the network; and
transmitting the data to the network using a first carrier, wherein the first carrier is from a first set of one or more carriers or a second set of carriers different to the first set, and wherein the carrier is from the first set or the second set dependent on a parameter of the data.

50. The method of claim 49:
wherein the request indicates the parameter of the data, and the method comprises receiving an indication of the first carrier in response to the request; and/or
wherein the request identifies the first carrier.

51. The method of claim 49:
wherein the method comprises determining a list of carriers ordered based on a characteristic of the carriers;
wherein the first set comprises one or more first carriers in the list;
wherein the second set comprises carriers in the list not in the first set.

52. The method of claim 51, wherein the characteristic comprises uplink Received Signal Strength Indicator (RSSI), uplink Signal to Interference and Noise Ratio (SINR), uplink interference level, downlink RSSI, downlink SINR, and/or downlink interference level.

53. The method of claim 49, further comprising:
receiving an indication of the first set from the network; and
receiving an indication of the second set from the network.

54. The method of claim 49, wherein the sending the request to the network comprises, in response to an indication of the first and second sets not being received from the network, sending a request to the network to use an anchor carrier or a carrier other than the anchor carrier based on the parameter of the data.

55. The method of claim 49, further comprising selecting the first carrier by selecting a carrier from the first set or a carrier from the second set based on the parameter of the data.

56. The method of claim 49, wherein the parameter comprises a delay tolerance, a data type, a latency constraint, a reliability requirement, and/or an exception indicator.

57. The method of claim 49, wherein the carriers in the first set are reserved for transmission of data having a predetermined value of the parameter.

58. A method, in a node in a wireless network, of receiving data from a User Equipment (UE), the method comprising:
receiving a request from the UE for transmission of the data to the network; and
receiving the data from the UE using a first carrier, wherein the first carrier is from a first set of one or more carriers or a second set of carriers different to the first set, and wherein the carrier is from the first set or the second set dependent on a parameter of the data.

59. The method of claim 58:
wherein the request indicates the parameter of the data, and the method comprises sending an indication of the first carrier to the UE in response to the request; and/or
wherein the request identifies the first carrier.

60. The method of claim 58, further comprising sending an indication of the first and second sets of carriers to the UE.

61. The method of claim 60:
further comprising determining a list of carriers ordered based on a characteristic of the carriers;
wherein the first set comprises one or more first carriers in the list, and the second set comprises carriers in the list not in the first set.

62. The method of claim 61, wherein the characteristic comprises uplink Received Signal Strength Indicator (RSSI), uplink Signal to Interference and Noise Ratio (SINR), uplink interference level, downlink RSSI, downlink SINR, and/or downlink interference level.

63. The method of claim 58, wherein the parameter comprises a delay tolerance, a data type, a latency constraint, a reliability requirement, and/or an exception indicator.

64. The method of claim 58, wherein the carriers in the first set are reserved for transmission of data having a predetermined value of the parameter.

65. A wireless device for transmitting data to a network, the wireless device comprising:
processing circuitry;
memory containing instructions executable by the processing circuitry whereby the wireless device is operative to:
send a request to the network for transmission of the data to the network; and
transmit the data to the network using a first carrier, wherein the first carrier is from a first set of one or more carriers or a second set of carriers different to the first set, and wherein the carrier is from the first set or the second set dependent on a parameter of the data.

66. The wireless device of claim 65, wherein the parameter comprises a delay tolerance, a data type, a latency constraint, a reliability requirement, and/or an exception indicator.

67. A network node for receiving data from a wireless device, the network node comprising
processing circuitry;
memory containing instructions executable by the processing circuitry whereby the network node is operative to:
receive a request from the wireless device for transmission of the data to the network; and
receive the data from the UE using a first carrier, wherein the first carrier is from a first set of one or more carriers or a second set of carriers different to the first set, and wherein the carrier is from the first set or the second set dependent on a parameter of the data.

68. The network node of claim 67, wherein the parameter comprises a delay tolerance, a data type, a latency constraint, a reliability requirement, and/or an exception indicator.
